(19) United States
(12) Patent Application Publication
(10) Pub. No.: US 2025/0211136 A1
(43) Pub. Date: Jun. 26, 2025

(54) Thrust Production via Quantized Inertia

(71) Applicant: Richard Marion Mansell, Covington, VA (US)

(72) Inventor: Richard Marion Mansell, Covington, VA (US)

(21) Appl. No.: 18/785,884

(22) Filed: Jul. 26, 2024

Related U.S. Application Data
(63) Continuation of application No. 17/685,739, filed on Mar. 3, 2022, now abandoned.
(60) Provisional application No. 63/293,398, filed on Dec. 23, 2021.

(51) Int. Cl. H02N 1/00

(52) U.S. Cl. CPC H02N 1/006

(57) ABSTRACT

The present disclosure relates to a system and method that produces thrust without a propellant or any physically moving parts. The disclosed method produces thrust by accelerating electrons between a multilayer capacitive stack and taking advantage of a conductive dampener that makes up a single thrust unit. For example, as power is applied to a first conductive layer separated by a second conductive layer by at least one dielectric layer, the electrons accelerating from the first layer produce a thrust whose direction is determined by the presence of a cover layer. Multiple middle conductive layers with corresponding dielectric layers can provide thrust scalability. Stacked thrust units with a minimum of a calculated distance between said units can also scale the thrust observed. Specialty materials with built in dielectrics such as anodized aluminum can further improve the thrust unit.

### CROSS-REFERENCE TO RELATED APPLICATIONS

This application is a continuation of U.S. patent application Ser. No. 17/685,739, filed Mar. 3, 2022, which claims the benefit of U.S. Provisional Application No. 63/293,398, filed Dec. 23, 2021, the disclosure of which is hereby incorporated herein by reference.

### BACKGROUND

Propulsion of objects and vehicles are essential to transportation of goods, movement of people, transmission of pieces of communication and other aspects of our modern way of life. Propulsion is usually achieved via one of numerous forms of mechanical actions. This could include the wheel of a car turning on the road, a propeller on an aircraft screwing through the air, or rocket propellant being thrust in one direction to induce movement in the opposite direction. Other commonly used forms of propulsion include chemical rocket thrust and electrical propulsion via ion drives.

### SUMMARY

Embodiments of the disclosure are directed to a thrust device that is configured to propel an object using quantized inertia.

In a first embodiment a thrust device is disclosed. The thrust device comprises: a first cover layer including a central axis; a first conductive layer positioned a first distance from the first cover layer about the central axis, wherein the first conductive layer is connected to a first terminal of a controller; a second conductive layer positioned a second distance from the first conductive layer about the central axis, wherein the second conductive layer is connected to a second terminal of the controller; a non-conductive medium positioned between the first cover layer and the first conductive layer; and at least one dielectric layer positioned between the first conductive layer and the second conductive layer, wherein, upon a current being applied by the controller between the first conductive layer and the second conductive layer, thrust is produced by the thrust device in a first direction when electrons accelerate in a second direction, wherein the first direction is opposite of the second direction.

In a second embodiment a thrust system is disclosed. The thrust system comprises: an object; and a plurality of thrust devices coupled to the object to propel the object, wherein each of the plurality of thrust devices comprises: a first cover layer including a central axis; a first conductive layer positioned a first distance from the first cover layer about the central axis, wherein the first conductive layer is connected to a first terminal of a controller; a second conductive layer positioned a second distance from the first conductive layer about the central axis, wherein the second conductive layer is connected to a second terminal of the controller; a non-conductive medium positioned between the first cover layer and the first conductive layer; and at least one dielectric layer positioned between the first conductive layer and the second conductive layer, wherein, upon a current being applied by the controller between the first conductive layer and the second conductive layer, thrust is produced by the thrust device in a first direction when electrons accelerate in a second direction, wherein the first direction is opposite of the second direction.

In a third embodiment a reversible thrust device is disclosed. The reversible thrust device comprises: a first cover layer including a central axis; a first anodized layer positioned a first distance from the first cover layer about the central axis, wherein the first anodized layer is connected to a first terminal of a controller; a second anodized layer a second distance from the first anodized layer about the central axis, wherein the second anodized layer is connected to a second terminal of the controller; a second cover layer a third distance from the second anodized layer about the central axis; a first non-conductive medium positioned between the first cover layer and the first anodized layer; a second non-conductive medium positioned between the second anodized layer and the second cover layer; and at least one magnet extending from a first edge of the first anodized layer to a second edge of the second anodized layer, wherein the first edge of the first anodized layer and the second edge of the second anodized layer are along a same plane; wherein, upon a current being applied by the controller between the first conductive layer and the second conductive layer, thrust is produced by the thrust device in a first direction when a flow of electrons is in a second direction, wherein the first direction is opposite of the second direction.

In a fourth embodiment, a method to produce thrust is disclosed. The method comprises: positioning a first cover layer along a central axis; positioning a first conductive layer a first distance from the first cover layer about the central axis; positioning a second conductive layer a second distance from the first conductive layer about the central axis; positioning a non-conducting medium between the first cover layer and the first conductive layer; and positioning at least one dielectric layer between the first conductive layer and the second conductive layer; and causing an electric current to flow from the second conductive layer towards the first conductive layer, wherein the electric current causes electrons to accelerate from the second conductive layer towards the first conductive layer causing the production of thrust in a direction that is towards the first conductive layer.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an example configuration of a thrust unit.

FIG. 2 illustrates another example configuration of a thrust unit.

FIG. 3 illustrates an example configuration of an electrically reversible thrust unit.

FIG. 4 illustrates another example configuration of the electrically reversible thrust unit.

FIG. 5 illustrates an example configuration of an electrically reversible thrust unit with a controller.

FIG. 6 illustrates an example configuration of a controller from FIGS. 3-5.

FIG. 7 illustrates another example configuration of a controller from FIGS. 3-5 for reverse thrust implementations.

FIG. 8 illustrates an example external thrust bus configuration.

FIG. 9 illustrates an example internal thrust bus configuration.

FIG. 10 illustrates an example configuration of a thrust unit stack.

FIG. 11 illustrates an isometric front view of an example configuration of an electro-magnetic thrust unit.

FIG. 12 illustrates a side view of the example electro-magnetic thrust unit from FIG. 11.

FIG. 13 illustrates an example alternative configuration of the electro-magnetic thrust unit.

FIG. 14, which includes FIGS. 14a and 14b, illustrates different views of a stack of electro-magnetic thrust units.

FIG. 15, which includes FIGS. 15a and 15b, illustrates different views of a stack of electro-magnetic thrust units.

FIG. 16, which includes FIGS. 16a and 16b, illustrates example implementations of thrust units in a satellite.

FIG. 17, which includes FIGS. 17a-d, illustrate example implementations of thrust units in different commercial applications.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In general, the subject matter of the present disclosure relates to a thrust device that can be configured to propel an object using quantized inertia. The disclosed thrust device may produce thrust without a propellant or any physically moving parts by accelerating electrons between a multilayer capacitive stack and taking advantage of a conductive dampener that makes up a single thrust unit.

For example, typically thrust used to propel objects are produced using mechanical thrust, chemical rocket thrust or electrical thrust. In some examples, mechanical motion, which includes turning wheels and boat propellers, is created when an object pushes off against another object. For example, mechanical motion is created when wheels push against the road surface or when a boat propeller pushes off against the water. Mechanical motion is simple, easy to replicate and can be powered by a number of different power sources, including an electric motor, an internal combustion engine, a jet engine or even humans.

However, there are several disadvantages to propulsion or thrust via mechanical methods, including: (i) loss of thrust when traction between the mechanical device and the substance it is pushing off of is lost; (ii) stress on the mechanical device, surface, object, and/or substance that the mechanical device is pushing off against, which may lead to breakage and loss of thrust; (iii) the reactionary force can endanger other objects, devices and people within the vicinity of the mechanical devices; and (iv) mechanical propulsion may not work within environments where there is nothing to push off against, such as in the vacuum of space.

Chemical rocket thrust is a common way to produce thrust and propel objects through vacuum. Rockets use chemical rocket thrust to propel through the vacuum of space. Rockets may also use chemical rocket thrust in atmospheres where the thrust needed to move an object cannot be attained using mechanical thrust due to the lack of atmospheric density.

However, there are several disadvantages to propulsion or thrust via chemical rocket methods, including: (i) expelling waste and residue; (ii) the expulsion of waste and residue causing breakage and harm to objects and humans in the path of the expulsion; (iii) using non-renewable energy sources in creating the thrust; and (iv) vehicles that create propulsion using chemical rocket thrust having to carry all of their fuel and once depleted, delays due to refueling and waste due to the discarding of the vehicle.

Electric propulsion via ion drives is a variation of the chemical rocket thrust mechanism that allows a vehicle to use renewable energies such as electricity from solar arrays to propel a propellant out of a vehicle. Although there are advantages to electric ion drives over chemical rocket drives, there are still some disadvantages, including: (i) vehicles having to carry all of their fuel; (ii) vehicles having to expel something in one direction so as to provide thrust in the other direction, which can lead to breakage and harm of objects and humans in the path of the expulsion; and (iii) expulsions from vehicles leaving behind waste and residue.

The present disclosure overcomes the disadvantages associated with other commonly used methods of producing thrust. For example, the disclosed method produces thrust using a quantized inertia method. The quantized inertia method produces thrust by accelerating electrons between a multilayer capacitive stack and taking advantage of a conductive dampener.

For example, the present disclosure includes a thrust device that may be configured to include one or more thrust units. Each thrust unit may include a combination of alternating conductive layers and dielectric layers connected to a power source. When power is applied using the power source, electrons are accelerated between the conductive layers and through the dielectric layers. For example, cover layers may be positioned in different configurations within each of the thrust units. Depending on the positioning of the cover layers within the thrust unit, the acceleration of electrons may produce thrust in the opposite direction or the same direction as the electrons being accelerated. The production of thrust may continue as long as power is applied. The thrust force may be directly proportional to the acceleration of the electrons, which in turn may be directly proportional to the applied power.

For example, the quantized inertia method produces thrust due to an inequality of Unruh radiation on either side of the conductive layer to which voltage is being applied. Typically, the inequality of Unruh radiation may produce a stronger force behind an object in opposition to the forward acceleration, which is referred to and exhibited as inertial mass. However, the unique configuration of conductive layers and cover layers along with a very thin dielectric layer in the disclosed thrust device results in an inequality that produces thrust in the direction desired. The exhibited thrust is produced from within the thrust unit without any outside forces, save for the electrical energy flowing from the power source.

Vehicles propelled using the thrust produced by the disclosed quantized inertia method do not have to carry fuel or be periodically refueled. The vehicles also do not produce any waste or residue, and the power supply used to apply power to the thrust device may be from a renewable energy source such as solar energy. Thus, the quantized inertia method of producing thrust may resolve the disadvantages created by the mechanical, chemical rocket and electrical methods for producing thrust and can be advantageous to use in satellites and for space travel, among other uses.

Thrust produced by the disclosed thrust unit may be proportional to the surface area of the conductive layers within the thrust unit minus the surface area of the first conductive layer within the thrust unit. In some examples, increasing the surface area of the conductive layers within each thrust unit by stacking multiple conductive layers along with their corresponding dielectric layers within a single thrust unit and stacking multiple thrust units together within a thrust device may be a way to scale the total amount of thrust produced by the disclosed thrust device.

For example, when an object is accelerated in one direction, an information horizon, otherwise known as a Rindler horizon, develops in the opposite direction to the acceleration vector of the object since information from behind the information horizon cannot catch up to the accelerating object. There is thus an information vacuum on the side of the accelerating object. The information vacuum or horizon produces Unruh radiation which is dampened close to the horizon. The resulting gradient produces a force opposite in direction to the acceleration of the accelerated object and produces what is commonly referred to as the property of inertial mass.

When voltage with an electrical potential that is higher than the work function of a conductive material is applied to two conductive materials so that one is a cathode and the other is an anode, charged particles such as electrons are emitted from the cathode toward the anode. The charged particles are accelerated from the cathode toward the anode with energy equaling the difference between the actual voltage applied and the work function of the cathode's material. The accelerating charged particles are normally pulled back by the aforementioned information vacuum (inertia). A unique placement of the conductive materials so that they are close enough to each other to be within the parameters of a Casimir cavity, can reverse the aforementioned gradient in Unruh radiation and change the typical Unruh radiation-based forces of inertia. The dampening or cancellation of the normally experienced inertial force can result in a net positive reactionless force or thrust in the same direction as the accelerated particles. Positioning a third conductive material, sometimes referred to as a cover plate, in the opposite direction to the accelerated particles' acceleration vector, but closer than the accelerated object's Rindler horizon can not only further dampen the Unruh radiation and force of inertia but can also reverse the direction of the thrust experienced. The thrust would then be experienced in the opposite direction to the charged particle's velocity.

A number of parameters can be adjusted to increase the net positive thrust production. For example, thrust production may be increased by increasing the voltage applied to the conductive layers. For example, when the applied voltage is increased, the acceleration of the charged particles also increases, resulting in a higher net positive force experienced. In another example, the thrust production may also be increased by decreasing the distance between the cathode and the anode. For example, when distance between the cathode and anode is decreased, the Casimir effect may increase, resulting in an increase of the dampening of Unruh radiation.

The inertia from an asymmetric Casimir Effect is described in greater detail in McCulloch, M. E. “Inertia from an Asymmetric Casimir Effect.” EPL (Europhysics Letters), 101, 59001. February 2013. https://arxiv.org/abs/1302.2775.

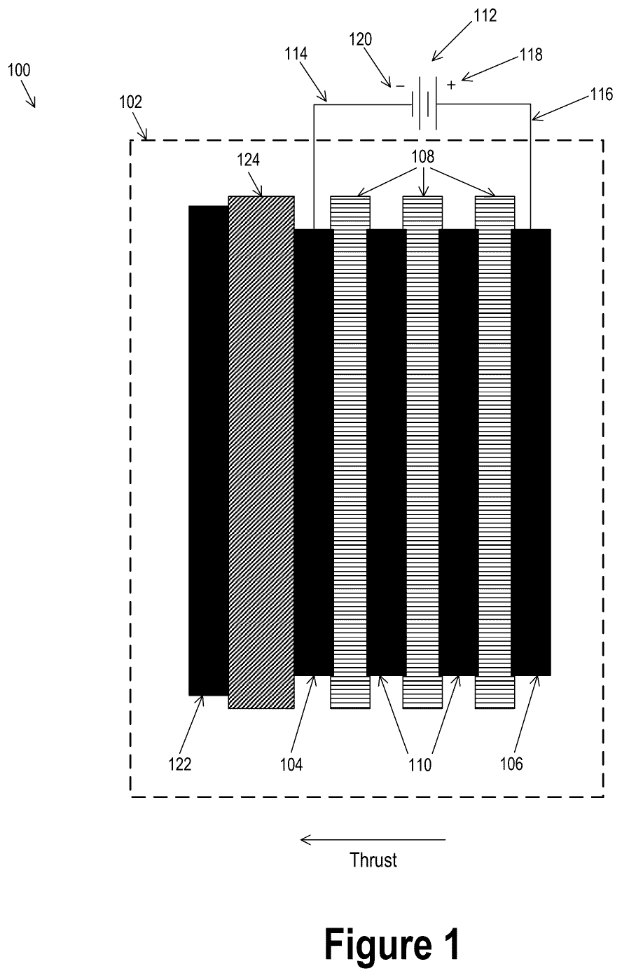

FIG. 1 illustrates an example configuration 100 of a thrust unit 102. The example thrust unit 102 is configured to include a conductive source layer 104 capacitively coupled to a conductive drain layer 106 with at least one dielectric layer 108 separating the conductive source layer 104 from the conductive drain layer 106. In some examples, there may be a single dielectric layer 108 separating the conductive source layer 104 and the conductive drain layer 106, wherein the conductive source layer 104 is coupled to a dielectric layer 108, which in turn is coupled to the conductive drain layer 106. In other examples, there may be a plurality of alternating dielectric layers 108 and conductive middle layers 110 that may be configured to separate the conductive source layer 104 from the conductive drain layer 106. The total surface area of the conductive layers is directly proportional to the amount of thrust produced. Thus, the number of conductive middle layers 110 may directly impact the amount of thrust produced.

For example, the example thrust unit 102 is configured to include a conductive source layer 104 that is capacitively coupled to two conductive middle layers 110 and a conductive drain layer 106, wherein each of the layers are separated by a dielectric layer 108. The conductive layers 104, 106, 110 are configured to be parallel to each other with the dielectric layers 108 separating each of the conductive layers 104, 106, 110. Although only two pairs of conductive middle layers 110 are illustrated in FIG. 1, more or fewer number of conductive middle layers 110 and corresponding dielectric layers 108 are possible with a minimum of at least one dielectric layer 108 between the conductive source layer 104 and the conductive drain layer 106.

The conductive source layer 104 and the conductive drain layer 106 may be connected to the terminals of a power source 112 using wires 114 and 116 respectively. In some examples, the wires 114, 116 may be configured to dispel electrical energy evenly across the conductive source layer 104 and conductive drain layer 106. For example, the wires 114 and 116 may branch out into a plurality of small wires that may be spread across the surface of the conductive source layer 104 and conductive drain layer 106 in order to spread the flow of electrical energy across the surface of the conductive source layer 104 and conductive drain layer 106. Other ways of configuring the wires 114 and 116 are also possible.

The power source 112 may supply power to the conductive source layer 104 and conductive drain layer 106 using a form of direct current electrical power supply. In some examples, the power source 112 could be a steady direct current source or a pulsed direct current source. The type of power source 112 may be selected based on the application of the thrust unit 102 and the type of the dielectric layers 108. For example, a pulsed direct current source may produce more efficient thrust when certain dielectric layers 108 used can only withstand short time periods of high voltage without breaking down. In another example, a pulsed direct current source may be used in a thrust unit 102 when precise short bursts of thrust are needed. Other types of power sources are also possible.

For example, the power source 112 may receive power from any electrical energy generating power sources such as batteries, alternators, solar arrays, nuclear power source, or even pedal power. For example, a backup pedal power device to provide power for spacecraft equipped with the example thrust unit 102 would allow astronauts to power their spacecraft to maneuver or change orbits by pedaling.

The power source 112 may include a positive terminal 118 and a negative terminal 120. In some examples, the positive terminal 118 of the power source 112 may be connected to the conductive drain layer 106 and the negative terminal 120 of the power source 112 may be connected to the conductive source layer 104. In other examples, the negative terminal 120 of the power source 112 may be connected to the conductive drain layer 106 and the positive terminal 118 of the power source 112 may be connected to the conductive source layer 104. The direction of the thrust produced by the thrust unit 102 may depend on the configuration of the connections of the positive and negative terminals 118, 120 of the power source 112.

For example, when the conductive source layer 104 of thrust unit 102 is positioned within a calculated Rindler horizon distance from the conductive drain layer 106 and upon the thrust unit 102 receiving a breakdown voltage or a field emission condition, electrons from the conductive source layer 104 may liberate from the conductive source layer 104 and accelerate towards the conductive drain layer 106. In some examples, the Rindler horizon distance is based on the accelerated electrons. For the Rindler horizon distance may be calculated by the equation: speed of light (c) squared divided by the acceleration of the electrons.

The example thrust unit 102 may also include a conductive cover layer 122 that is positioned parallel to the conductive source layer 104, conductive middle layers 110 and conductive drain layer 106 with a non-conductive layer or an air-gap 124 between the conductive source layer 104 and the conductive cover layer 122. The conductive cover layer 122 may be used to increase the thrust capabilities of the thrust unit 102.

For example, the conductive cover layer 122 may be a conductive layer that is insulated from all other conductive layers 104, 106, 110, wires, surfaces and power source 112. The conductive cover layer 122 may be configured to include a surface area that is at least as large as or larger than the surface area of the conductive source layer 104 so as to shield the conductive source layer 104 from any outside radiation. The conductive cover layer 122 may be positioned no farther away from the conductive source layer 104 than a calculated Rindler horizon distance that is based on the accelerated electrons within the thrust unit 102.

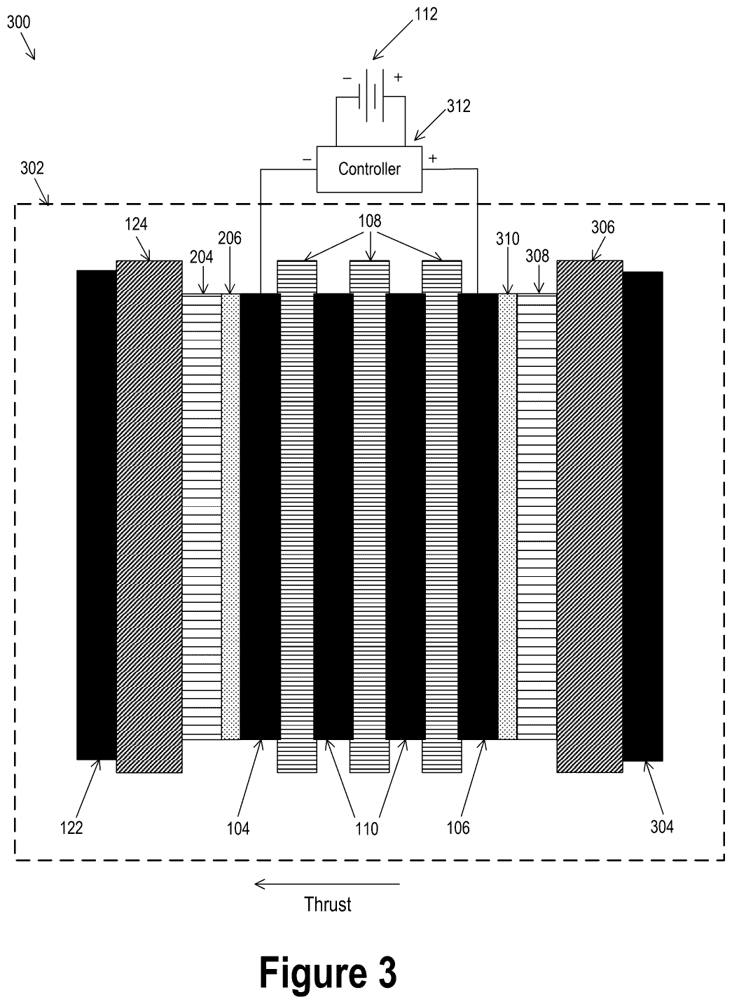

In some examples, a conductive cover layer 122 may be included adjacent to the conductive drain layer 106 as well so that the direction of the thrust can be reversed without reconfiguring the conductive layers within the thrust unit. FIG. 3 describes the use of conductive cover layers on both ends of the conductive layers in additional detail.

For example, as illustrated in FIG. 1, when the power source 112 supplies power to the thrust unit 102 with the positive terminal 118 of the power source 112 connected to the conductive drain layer 106 and the negative terminal 120 of the power source 112 connected to the conductive source layer 104, electrons may be accelerated between the conductive layers 104, 106, 110 and through the dielectric layers 108 in order to produce an overall effective thrust in a direction that flows from the conductive drain layer 106 and towards the conductive source layer 104. When the power source 112 supplies power to the thrust unit 102 with the positive terminal 118 of the power source 112 connected to the conductive source layer 104 and the negative terminal 120 of the power source connected to the conductive drain layer 106, electrons may be accelerated between the conductive layers 104, 106, 110 and through the dielectric layers 108 in order to produce an overall effective thrust in a direction that flows from the conductive source layer 104 and towards the conductive drain layer 106.

In some examples, the conductive cover layer 122 may be used to control the direction of the thrust produced by some of the conductive layers. For example, without a conductive cover layer 122, when power is applied to the thrust unit 102, with the positive terminal 118 of the power source 112 connected to the conductive drain layer 106 and the negative terminal 120 of the power source 112 connected to the conductive source layer 104, the conductive source layer 104 and at least the conductive middle layer 110 closest to the conductive source layer 104 may produce thrust in a direction towards the conductive drain layer 106, while the rest of the conductive middle layers 110 and the conductive drain layer 106 may produce thrust in a direction towards the conductive source layer 104. While the overall effective thrust produced by the thrust unit 102 may be in a direction towards the conductive source layer 104, the counter production of thrust in opposite directions from at least some of the conductive layers within the thrust unit 102 results in a loss in overall effective thrust produced by the thrust unit 102.

In some examples, the conductive cover layer 122 insulated by a non-conductive layer, such as an air-gap 124, and configured to be parallel to the conductive source layer 104 may act as a “dummy” conductive layer. Such a configuration may result in all conductive layers of the thrust unit 102, including the conductive source layer 104 and the conductive middle layer 110 closest to the conductive source layer 104, producing thrust in a direction towards the conductive cover layer 122 when the power source 112 supplies power to the conductive layers with the positive terminal 118 of the power source 112 connected to the conductive drain layer 106 and the negative terminal 120 of the power source 112 connected to the conductive source layer 104. Thus, use of a conductive cover layer 122 may facilitate all conductive layers 104, 106, 110 to produce thrust in the same direction and may result in the efficient production of thrust from the thrust unit 102.

The conductive layers may be selected and configured to effectively facilitate the acceleration of electrons from the conductive layers. For example, the thickness of the conductive layers, including the conductive source layer 104, conductive drain layer 106, the conductive middle layers 110 and the conductive cover layer 122 can be modified as appropriate to block out unwanted electrical and radiation sources that could interfere with the full thrust potential of the thrust unit 102.

Typically, the production of thrust is most efficient as the thickness of the conductive cover layer 122 increases and the thickness of the conductive source layer 104 and the thickness of the conductive middle layers 110 decreases. Example thickness ranges associated with increased thrust production includes 10 microns to 5 mm in thickness for the conductive cover layer 122 and 10 microns to 500 microns in thickness for the conductive source layer 104 and conductive middle layers 110. Other ranges for the thickness of the conductive layers 104, 106, 110, 122 are also possible.

The thickness of the conductive layers 104, 106, 110, 122 may be based on various considerations. For example, the thickness of the conductive cover layer 122 may impact the overall weight of the thrust unit 102 and the thickness of the conductive source layer 104 and conductive middle layers 110 may impact the proper functioning of the thrust unit. For example, when the thickness of the conductive source layer 104 and/or the conductive middle layers 110 are below a threshold level, the thrust unit may no longer produce thrust.

In some examples, in addition to the thickness of the conductive layers 104, 106, 110 and 122, the thickness of the dielectric layers 108 may also impact the efficient production of thrust by the thrust unit 102. The thickness of the dielectric layers 108 may be minimized such that the physical distance between any adjacent conductive layers is minimized. For example, the thickness of the dielectric layers 108 may range from 10 micron to 25 microns. Other ranges for the thickness of the dielectric layers are also possible.

In other examples, the dielectric layers 108 may be composed of a material that includes high voltage breakdown levels such that the voltage potential that could be used between successive conductive layers may be maximized. The conductive layers 104, 106, 110 may be composed of conductive materials that easily emit electrons. For example, the conductive layers 104, 106, 110 may also be composed of conductive materials such as aluminum or copper. Although aluminum is used as an example of the conductive material throughout this disclosure, other types of conductive materials may also be used to form the conductive layers 104, 106, 110, 122.

In some other examples, the conductive layers 104, 106, 110 may be composed of conductive materials with an attached dielectric such as anodized aluminum sheets or plates. In some examples, anodized aluminum sheets may include aluminum foils. The internal aluminum of anodized aluminum sheet/plate may function as the conductive layer while the outer layer of aluminum oxide from the anodized aluminum sheet/plate may function as the dielectric layer 108. For example, the anodized aluminum sheets/plates may be layered directly without any separate dielectric layer material added in between. The anodized process also means that the dielectric layer would be scratch/damage resistant unlike polyimide or other similar dielectric materials. Other types of materials can also be used for the conductive layers 104, 106, 110 and dielectric layers 108.

Thus, in one example, the thrust unit 102 may be composed of alternating layers of aluminum and dielectric materials. In another example, the thrust unit 102 may be composed of layers of anodized aluminum. In yet another example, the thrust unit 102 may be composed of alternating layers of anodized aluminum and aluminum. To minimize the weight of the thrust unit, layers of aluminum used in the thrust device may be as thin as half a micro-meter. In some examples, the layers of aluminum can also be thicker or thinner than the half a micro-meter thickness.

In some examples, another consideration to facilitate the efficient emission of electrons from the conductive layers may include coating the conductive layers 104, 106, 110 with electron emission enhancing coating. For example, the conductive layers 104, 106, 110 may be coated with materials such as barium oxide or strontium oxide to enhance the emission of electrons from the conductive layers 104, 106, 110. Other types of electron emission enhancing materials can also be used to coat the conductive layers 104, 106, 110.

In some examples, electron emission may be enhanced by including emission enhancing structures within the conductive layers 104, 106, 110. Generally, electrons may be emitted more easily from a surface that ends in points rather than a smooth or otherwise rounded surface. Thus, the emission of electrons from the conductive layers 104, 106, 110 may be enhanced if the conductive layers 104, 106, 110 are covered in surface irregularities, including microscopic points in the direction of the drain layer.

When the conductive source layer 104 includes irregular structures, the electrons may emit from the conductive source layer 104 and travel towards the conductive drain layer 106 more easily. In other words, when the conductive source layer 104 includes irregularities along the surface of the conductive source layer 104, the electrons may be emitted by the conductive source layer 104 at a lower power supply voltage level than when a conductive source layer 104 without the microscopic structures is used.

For example, each of the conductive layers 104, 106, 110 may be composed of one or more aluminum layers covered in nano particles such as nano-barbs or nanotubes to provide irregularities to the surface of the conductive layers to enhance electron emission. In some examples, the nano-barbs or nanotubes may be composed of another material, such as boron-nitride. In other examples, nano particles may be composed of aluminum.

In one example, the aluminum layers may be assembled such that the nano-barbs or nanoparticles are compressed in-between aluminum layers. For example, the aluminum-nano particle-aluminum “sandwich” may provide for an irregular surface to the outside of the conductive layer “sandwich” due to the nano particles deforming the malleable aluminum. The aluminum-nano particle-aluminum “sandwich may be manufactured by compressing two aluminum sheets with nano particles dispersed in between the sheets into a single aluminum layer. The assembled aluminum sheets may be used as the conductive layers 104, 106, 110.

In another example, the aluminum layers may be assembled by covering the aluminum layers with symmetrically placed or etched nano pillars. Nano pillars can be mass produced via stamping procedures or lithography.

In yet another example, the irregularities to the surface of the conductive layers 104, 106, 110, 122 may be configured using a Spindt array. For example, the surface of the conductive layers 104, 106, 110 may be covered in a separate dielectric and gate layer and the dielectric layer and gate layers may be pierced through periodically across the entire surface with micrometer sized holes allowing the underlying conductive layers 104, 106, 110 to be exposed. A pointed nano pillar may be created in the conductive layer by etching away the surrounding conductive material. A positive voltage signal may be applied to the gate layer that attracts electrons from the etched nano pillars of the conductive layers 104, 106, 110 and the electrons may shoot through the hole in the dielectric and gate layers and into the dielectric layer 108.

In yet another example, the irregularities to the surface of the conductive layers 104, 106, 110 may be formed using chemical etching. For example, the conductive layers 104, 106, 110 may be etched using chemical processes to create irregularities that enhance electron emissions. For example, if an anodized aluminum layer is used to form the conductive and dielectric layers 104, 106, 110, 108, the anodized aluminum layer may be etched to a satin or more irregular surface quality before the anodizing process in order to form irregularities within the surface.

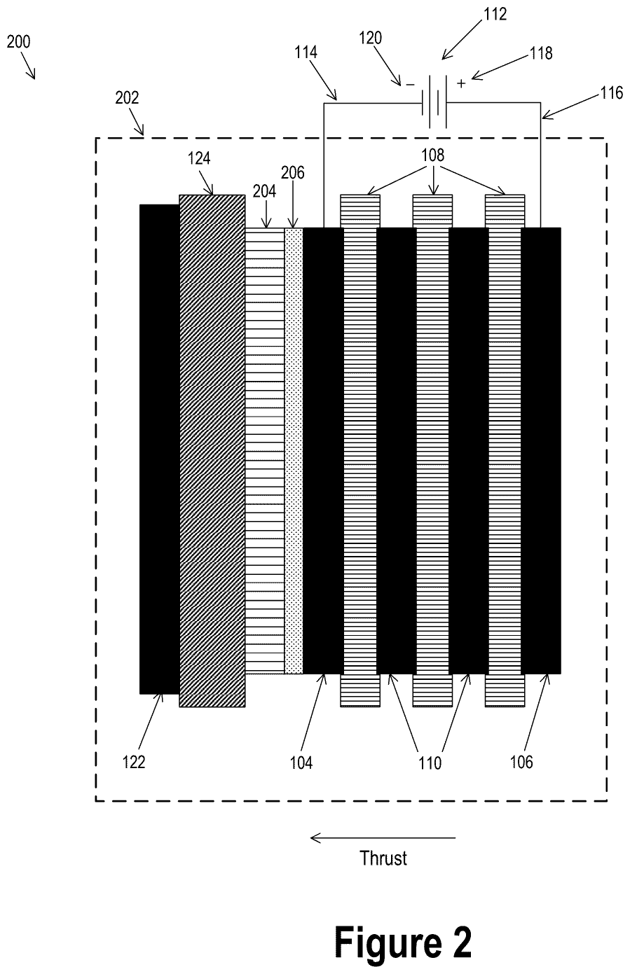

FIG. 2 illustrates an example configuration 200 of a thrust unit 202. For example, thrust unit 202 is similar to the configuration of the thrust unit 102 from FIG. 1, but includes an optional heating/cooling element 204 and an optional high-temperature insulative layer 206 in addition to the conductive layers 104, 106, 110, 122, dielectric layers 108 and non-conductive layer or air-gap 124 described in FIG. 1.

The heating/cooling element 204 may be configured to heat or cool the conductive layers 104, 106 and 110 of the thrust unit 202. For example, the heating/cooling element 204 may be configured to heat the conductive layer to increase the electron emission from the conductive layers 104, 106, 110, which in turn, may result in an increased production of thrust. The heating/cooling element 204 may be configured to cool the conductive layers 104, 106, 110 when operation of the thrust device is desired to be stopped immediately. The cooling element within the heating/cooling element 204 may be implemented using piezoelectric, phase change or liquid technology. The heating element within the heating/cooling element 204 may be implemented using any type of heating technologies.

Although FIG. 2 only illustrates the heating/cooling element 204 adjacent to the conductive source layer 104, similar heating/cooling elements may be arranged adjacent to each of the conductive middle layers 110 and the conductive drain layer 106 in order to increase the electron emissions from the conductive layers 104, 106, 110 and increase thrust production.

In some examples, the high voltage in the conductive source layer 104 may have an adverse effect on the heating/cooling element 204. Therefore, an optional high-temperature insulative layer 206 may be optionally used between the conductive source layer 104 and the heating/cooling element 204 to protect the heating/cooling element 204 from damage. In other examples, a similar high-temperature insulative layer 206 may be optionally used to protect the heating/cooling elements 204 arranged adjacent to the conductive middle layers 110 and conductive drain layer 106.

FIG. 3 illustrates an example configuration 300 of an electrically reversible thrust unit 302. For example, the electrically reversible thrust unit 302 is configured to electrically control the direction of thrust production without requiring any physical or mechanical rearrangement of the conductive layers of the electrically reversible thrust unit 302.

For example, electrically reversible thrust unit 302 is similar in configuration to the thrust unit 202 from FIG. 2, but additionally includes a controller 312 to control the supply of power to the conductive layers 104, 106 and a conductive cover layer 304, a non-conductive layer or air-gap 306, an optional heating/cooling element 308 and an optional high-temperature insulative layer 310 that are adjacent to the conductive drain layer 106. The configuration and implementation of the conductive cover layer 304, the non-conductive layer or air-gap 306, the optional heating/cooling element 308 and the optional high-temperature insulative layer 310 are similar to the configuration and implementation of the conductive cover layer 122, the non-conductive layer or air-gap 124, the optional heating/cooling element 204 and the optional high-temperature insulative layer 206 as described in relation to FIG. 2.

In an example, the electrically reversible thrust unit 302 includes the conductive source layer 104, the conductive drain layer 106, conductive middle layers 110 and dielectric layers 108 in a similar configuration as described in relation to FIG. 2. However, in addition to the conductive cover layer 122 described in relation to thrust unit 202 from FIG. 2 and positioned adjacent to the conductive source layer 104, the electrically reversible thrust unit 302 also includes the conductive cover layer 304 that is adjacent to the conductive drain layer 106. Similar to the configuration of the conductive source layer 104 side of the thrust unit 202 of FIG. 2, the electrically reversible thrust unit 302 may also include a non-conductive layer or air-gap 306 that insulates the conductive cover layer 304.

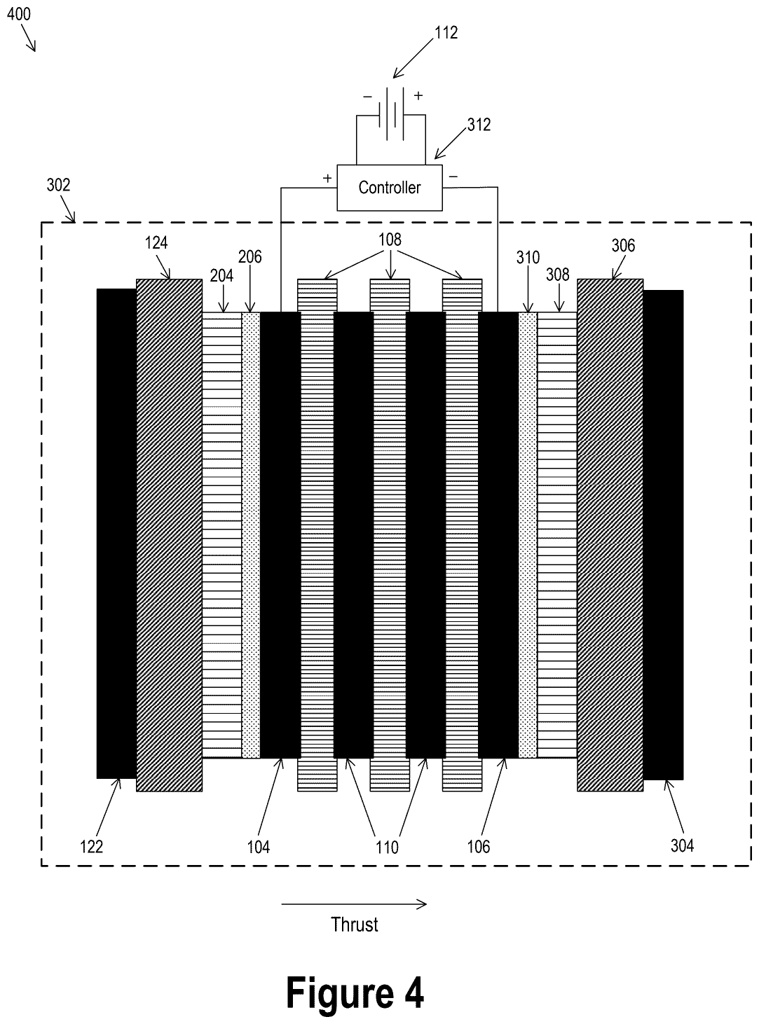

In addition to the heating/cooling element 204 associated with the conductive source layer 104 from thrust unit 202 of FIG. 2, the electrically reversible thrust unit 302 also includes an optional heating/cooling element 308 that is positioned between the non-conductive layer or air-gap 306 and the conductive drain layer 106 an optional high-temperature insulative layer 310 that is adjacent to the conductive drain layer 106 in order to enhance the emission of electrons when the polarity of the power is reversed in order to produce thrust in a reverse direction as illustrated in FIG. 4.

In addition to the configuration of the conductive/non-conductive layers of the electrically reversible thrust unit 302, the electrically reversible thrust unit 302 also includes a controller 312 that is connected to the conductive source layer 104 and conductive drain layer 106 and configured to supply electric power to the conductive layers 104, 106.

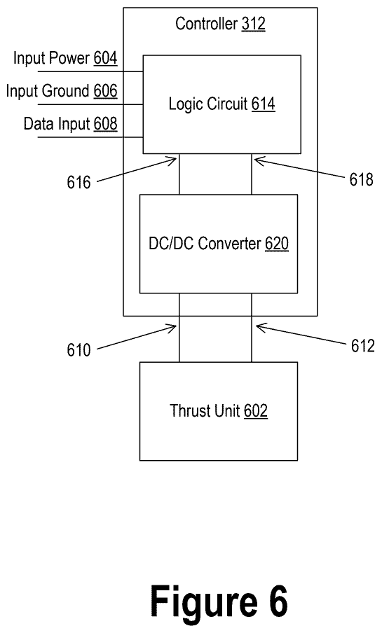

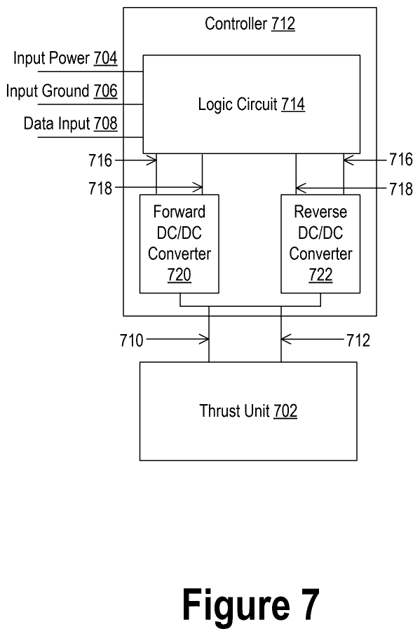

For example, the controller 312 may be configured to control the polarity of the electric power that is transmitted to the conductive source layer 104 and conductive drain layer 106. For example, in a first configuration that is illustrated in FIG. 3, the controller 312 may receive electric power from the power source 112 and control the polarity of the electric power being transmitted to the conductive source layer 104 and conductive drain layer 106 such that the conductive source layer 104 is configured to be the cathode and the conductive drain layer 106 is configured to be the anode. The reverse configuration is illustrated in FIG. 4 below. The configuration of the controller 312 is described further in relation to FIGS. 6-7.

When the controller 312 is configured to connect the positive terminal 118 of the electric power source to the conductive drain layer 106 and the negative terminal 120 of the electric power source to the conductive source layer 104, the conductive drain layer 106 serves as the anode and the conductive source layer 104 serves as the cathode. When a current is applied between the conductive source layer 104 and conductive drain layer 106 by the controller 312, the conductive layers 104, 106, 110 may emit electrons. The electrons may accelerate from the cathode towards the anode. In other words, electrons may accelerate from the conductive source layer 104 towards the conductive drain layer 106. The acceleration of electrons produces thrust. The direction of thrust produced due to the acceleration of electrons may depend on whether a conductive cover layer 122 is used in the implementation of the thrust unit.

For example, when a thrust unit that does not include a conductive cover layer 122, the thrust unit may produce thrust in a direction that follows the direction of electron acceleration. However, in the present example from FIG. 3, the electrically reversible thrust unit 302 includes a conductive cover layer 122. The use of a conductive cover layer 122 may cause the electrically reversible thrust unit 302 to produce thrust in a direction opposite to the direction of electron acceleration. Therefore, electrically reversible thrust unit 302, which includes conductive cover layer 122 may produce thrust in a direction that is from the conductive drain layer 106 towards the conductive when electrons accelerate in a direction from the conductive source layer 104 towards the conductive drain layer 106. FIG. 4 illustrates another example configuration 400 of the electrically reversible thrust unit 302. The conductive layers 104, 106 of electrically reversible thrust unit 302may be configured to receive power with a reverse polarity than the power received by the conductive layers 104, 106 in FIG. 3 and thus produce thrust in a reverse direction to the direction of thrust produced by the electrically reversible thrust unit 302 in FIG. 3.

For example, when the controller 312 is configured to connect the negative terminal 120 of the electric power source to the conductive drain layer 106 and the positive terminal 118 of the electric power source to the conductive source layer 104, the conductive drain layer 106 serves as the cathode and the conductive source layer 104 serves as the anode. Electrons from the conductive layers 104, 110, 106 are emitted and accelerate in a direction that may be from the conductive drain layer 106 and towards the conductive source layer 104. Because of the use of conductive cover layers 122, 304, the acceleration of the electrons produces thrust in a direction that is opposite of the direction of electron acceleration. Therefore, when electrons accelerate in a direction from the conductive drain layer 106 towards conductive source layer 104, the electrically reversible thrust unit 302 may produce thrust in a direction from the conductive source layer 104 and towards the conductive drain layer 106, as denoted by the thrust direction in FIG. 4.

The direction of the thrust produced by the electrically reversible thrust unit 302 in FIGS. 3 and 4 is controlled simply by reversing the polarity of the power supplied to the conductive source layer 104 and conductive drain layer 106. Thus, the electrically reversible thrust unit 302 can reverse the direction of thrust production without physical or mechanical changes to the configuration of the electrically reversible thrust unit 302 itself. For example, the conductive layers 104, 106 do not need to be physically switched for the direction of the thrust to be reversed.

In addition to using the electrically reversible thrust unit 302 to control the direction in which an object or vehicle associated with the electrically reversible thrust unit 302 is propelled, the electrically reversible thrust unit 302 may also be used to control the speed at which the object or vehicle associated with the electrically reversible thrust unit 302 is propelled. For example, when an object or vehicle that uses the electrically reversible thrust unit 302 as a propellant needs to be slowed down, the polarity of the power supply may simply be reversed for a period of time to slow down the movement of the object or vehicle.

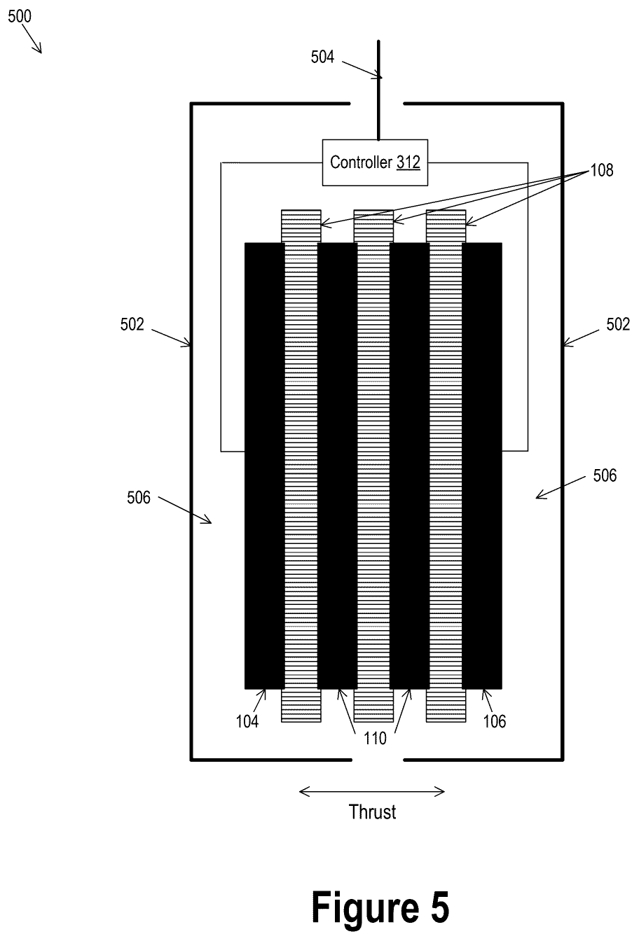

FIG. 5 illustrates an example configuration of an electrically reversible thrust unit 500 with controller 312. For example, instead of using conductive cover layers 122 and 304 as parallel plates adjacent to the conductive source layer 104 and conductive drain layer 106 as illustrated in FIGS. 3 and 4, the electrically reversible thrust unit 500 may be enclosed within an enclosure composed of two conductive halves 502 that serve as the conductive cover layers.

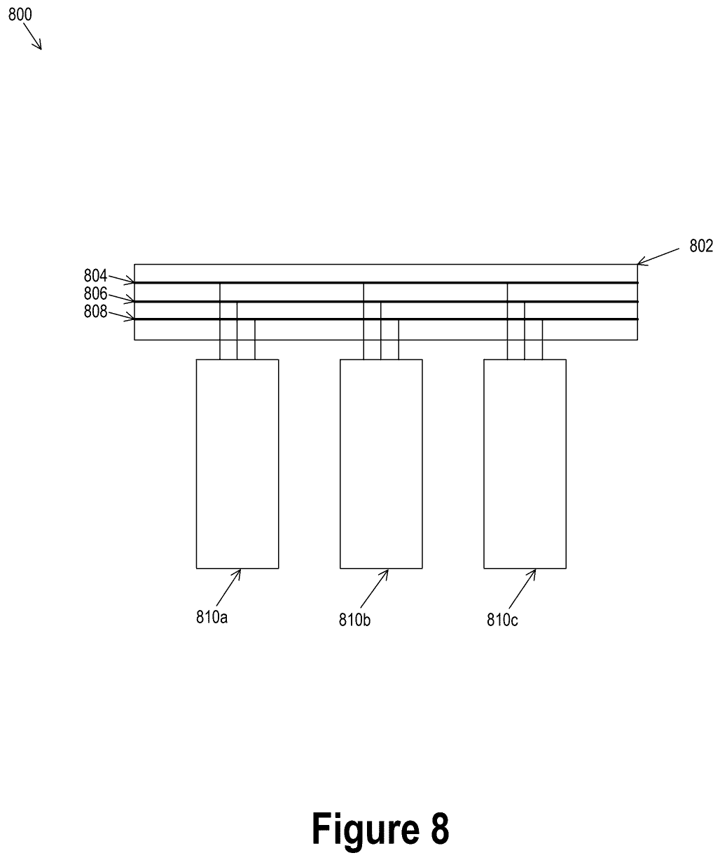

For example, the controller 312 may be configured to be connected to receive power and data from a main electrical power supply and computing system via a thrust bus 504 and transmit the power to the conductive source layer 104 and conductive drain layer 106. The conductive source layer 104 and conductive drain layer 106, although designated as “source” and “drain” may in reality alternate serving as the source and drain based on the polarity of the power provided by the controller 312. The configuration of the controller 312 is described further in relation to FIGS. 6-7 and the configuration of the thrust bus 504 is further described in relation to FIG. 8.

In some examples, the gap 506 between the two conductive halves 502 that serve as the cover layers and the conductive source layer 104 and conductive drain layer 106 may be filled with an insulating layer of non-conductive material to protect the conductive/dielectric layers of the thrust unit from outside thermal influences while also providing non-conductive separation from the two conductive halves 502 serving as the cover layers.

In FIG. 5, the layers of the thrust unit are illustrated with alternating solid black layers representing the conductive layers 104, 106, 110 and striped layers representing the dielectric layers 108. While the dielectric layers 108 are represented by distinct striped layers in FIG. 5 in order to visually distinguish the individual conductive and dielectric layers of the electrically reversible thrust unit 500, in reality, each combination of conductive layer and adjacent dielectric layer together may be composed of a single layer of anodized aluminum. In other words, a layer of anodized aluminum may include a conductive layer adjacent to a dielectric layer. In other examples other types of materials may be used to replace each combined layer of conductive layer and dielectric layer.

With the usage of anodized aluminum forming both the dielectric and conductive layers, no other materials are needed within conductive/dielectric layers of the electrically reversible thrust unit 500. In some examples, a dielectric film or tape may be additionally included along the outside edges of each anodized aluminum layer in order to prevent arcing along the edges where the dielectric film of aluminum oxide may be missing or might have been compromised during manufacturing.

For example, while other dielectrics may produce arcs or physical holes in the dielectrics during an over-voltage situation, anodized aluminum may not physically break down when an over-voltage situation occurs and is thus desirable in configuring the conductive/dielectric layers of the electrically reversible thrust unit 500. When anodized aluminum experiences an over-voltage situation, excess current may pass through the conductive/dielectric layers of the thrust unit and no arcing or physical breakdown may occur. If and when the voltage is brought back down to an acceptable level, the electrically reversible thrust unit 500 may go back to normal operation without any need for repairs.

FIG. 6 illustrates an example configuration of a controller 312 from FIGS. 3 and 4. For example, the controller 312 is configured to receive an input electrical power supply and transmit an output power supply to bias a thrust unit 602.

For example, the controller 312 is configured to receive an input electrical power supply, including an input power 604 and input ground 606, and a data input 608 and transmit a first power output 610 and a second power output 612 that is of a first polarity or a second polarity based on the data input 608, wherein the second polarity is a reverse of the first polarity. For example, the input power 604 and input ground 606 may be received from a main power source associated with the object or vehicle where the thrust unit 602 may be implemented. In some examples, the main power source may be a renewable power source, such as solar power generated from a solar array. Other types of power sources are also possible.

For example, the controller 312 includes a logic circuit 614 that may be optionally coupled to a DC/DC converter 620. For example, the logic circuit 614 may receive the input power 604 and input ground 606 and based on the value of the data input 608, may output a power and ground value to the DC/DC converter 620 via a first output port 616 and a second output port 618, which in turn may transmit the input power 604 and input ground 606 to the thrust unit 602 via a first power output 610 and a second power output 612 that corresponds to the input power 604 and input ground 606.

In some examples, the logic circuit 614 may simply convey the input power 604 and input ground 606 to the DC/DC converter 620. In other examples, the logic circuit 614 may include a radiation hardened microprocessor that monitors the current and voltage levels for the thrust unit 602 and communicates with a main computing system that is associated with the object or vehicle where the thrust unit 602 and controller 312 are implemented. For example, the logic circuit 614 may use a communication protocol such as CAN-bus, or I2C to communicate with the object or vehicle's main computing system. Other types of communication protocols may also be used. In other examples, the logic circuit 614 may monitor and/or control the optional heating/cooling elements 204, 308.

In some examples, the data input 608 may include a set of couplings for higher level communication protocols. In other examples, the data input may include an analog signal to indicate the amount of desired thrust output. For example, a data input 608 of “0V” may indicate “off” and a voltage level that is above 0V may correspond to a level of thrust proportional to the voltage level. In yet other examples, the data input 608 may be used to indicate the direction of thrust if the thrust unit 602 is a reversible thrust unit.

In some examples, the output from the logic circuit 614 may be transmitted to the optional DC/DC converter 620. In other examples, the output from the logic circuit 614 may be directly transmitted to the thrust unit 602. The DC/DC converter 620 may be optional based on the voltage level of the power received by the logic circuit 614. For example, when the power received by the logic circuit 614 is not compliant with the input power requirements of the thrust unit 602, the DC/DC converter may be used to convert the received power from the first output port 616 and second output port 618 of the logic circuit 614 to the appropriate output power as required by the thrust unit 602 and transmit the output power to the thrust unit 602 via a first power output 610 and second power output 612. The DC/DC converter 620 and/or logic circuit 614 may also be used for over-current protection, overload protection, current and/or voltage monitoring. For example, when an over-current or over-voltage situation is detected, the logic circuit 614 and/or DC/DC converter 620 may utilize a current feedback loop to lower the voltage automatically.

For example, the thrust unit 602 may include any configuration of a thrust unit, including thrust unit 102, thrust unit 202 or electrically reversible thrust unit 302. Other configurations of a thrust unit are also possible. The thrust unit receives the converter power from the optional DC/DC converter 620 or directly from the logic circuit and uses the power for the operation of the thrust unit 602.

The controller 312 may be implemented along an outside edge of the thrust unit 602, in the middle of the thrust unit or on a corner. The configuration of the controller 312 and thrust unit 602 may depend on the type and purpose of the thrust unit 602.

FIG. 7 illustrates another example configuration of controller 312 for reverse thrust implementations. The controller 312 may be configured to receive input power 704, input ground 706 and data input 708 from an electrical power source and a computing system associated with an object or vehicle where the thrust unit 702 may be implemented and transmit power through controller power outputs 710, 712 according to a forward polarity that facilitates forward thrust production or a reverse polarity that facilitates reverse thrust production of the thrust unit 702.

The controller 312 may include a logic circuit 714, a forward DC/DC converter 720 and a reverse DC/DC converter 722. The logic circuit 714 may pass on the input power signal 716 that includes the input power 704 and input ground 706, to the forward DC/DC converter 720 and the reverse DC/DC converter 722.

For example, the forward DC/DC converter 720 may be configured in a similar manner as the DC/DC converter 620 from FIG. 5. In some examples, the reverse DC/DC converter 722 may be configured to include a negative voltage converter. Other configurations of the reverse DC/DC converter 722 is also possible. In some examples, the forward DC/DC converter 720 and the reverse DC/DC converter may be isolated from one another using an optocoupler so as to not damage the converter that is turned off when the other converter is in use.

Based on the direction of thrust indicated by the data input 708, the logic circuit 714 transmits the input power signal 716 to the forward DC/DC converter 720 or the reverse DC/DC converter 722. In addition to transmitting the input power signal 716, the logic circuit 714 may also transmit a data line 718 to the forward DC/DC converter 720 and the reverse DC/DC converter 722. The data line 718 may be configured to transmit on/off signaling to the forward DC/DC converter 720 and reverse DC/DC converter 722. In addition to providing input regarding when the DC/DC converters need to be turned on/off, the data line 718 may also provide information regarding the required voltage levels, and feedback regarding over current.

If the forward DC/DC converter 720 is used, the input power signal 716 may be transmitted from the forward DC/DC converter 720 to the thrust unit 702 via controller power outputs 710, 712 with a forward polarity and the thrust unit 702 may produce a forward thrust. Alternatively, if the reverse DC/DC converter 722 is used, the input power signal 716 may be transmitted from the reverse DC/DC converter 722 to the thrust unit 702 via controller power outputs 710, 712 with a reverse polarity and the thrust unit 702 may produce a reverse thrust.

FIG. 8 illustrates an example external thrust bus configuration 800. The example external thrust bus configuration 800 may include a thrust bus 802 that may be shared between thrust units 810a-c of a stack of thrust units. The thrust bus 802 may be configured to include a power signal 804, ground signal 806 and data signal 808 that may be connected to the individual thrust units 810a, 810b, 810c within the stack of thrust units. In some examples, the power signal 804, ground signal 806 and data signal 808 from the thrust bus 802 may be configured to connect to the input power 604, 704, input ground 606, 706 and data input 608, 708 of controller 312 from FIGS. 6 and 7.

For example, when the thrust bus 802 is external to the thrust units 810a-c, each thrust unit can be easily removed or replaced when the thrust unit experiences damage or otherwise malfunctions without affecting the operation of the other thrust units in the stack of thrust units. Thus, an external thrust bus configuration 800 may be advantageous when the stack of thrust units is used to propel a serviceable object or vehicle, such as a spacecraft.

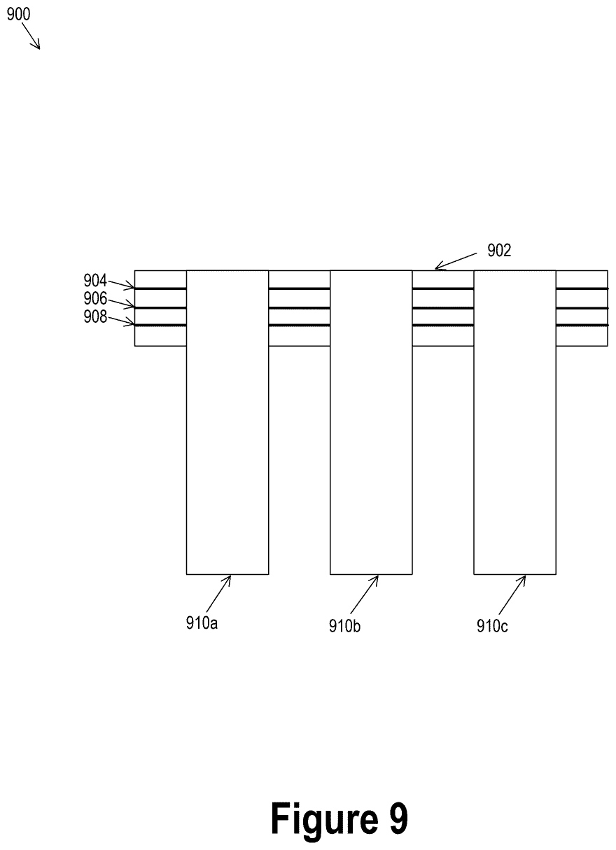

FIG. 9 illustrates an example internal thrust bus configuration 900. An internal thrust bus configuration 900 may be used when the stack of thrust units is used in non-serviceable object such as probes and satellites.

The example internal thrust bus configuration 900 may include a thrust bus 902 that may be shared between thrust units 910a-c of a stack of thrust units. The thrust bus 902 may be configured to include a power signal 904, ground signal 906 and data signal 908 that may be connected to the individual thrust units 910a, 910b, 910c within the stack of thrust units. In some examples, the power signal 904, ground signal 906 and data signal 908 from the thrust bus 802 may be configured to connect to the input power 604, 704, input ground 606, 706 and data input 608, 708 of controller 312 from FIGS. 6 and 7.

However, unlike the external thrust bus configuration 800, the thrust bus 902 of the internal thrust bus configuration 900 may be configured to physically be part of each thrust unit's 900a-c controller. For example, the thrust units 910a-c may be arranged such that the power signal 904, ground signal 906 and data signal 908 associated with the controller of each thrust unit may align with the power signal 904, ground signal 906 and data signal 908 of an adjacent thrust unit so as to form a stack of thrust units, thus forming the thrust bus 902.

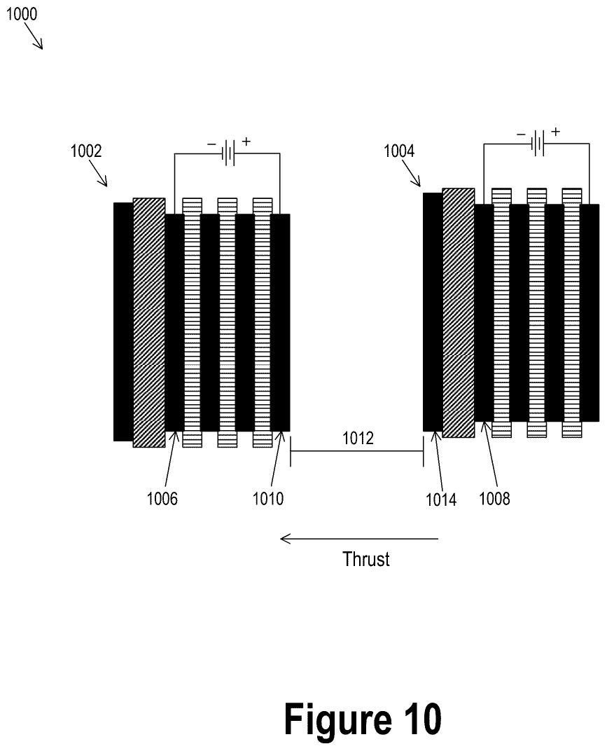

FIG. 10 illustrates an example configuration of a thrust unit stack 1000. Although the present example illustrates a thrust unit stack 1000 that only includes two thrust units, more thrust units may be stacked together within a thrust unit stack 1000.

For example, the placement of each thrust unit within the thrust unit stack 1000 affects the overall thrust production of the thrust unit stack 1000. In some examples, the positioning of the thrust units compared to the adjacent thrust units and the spacing between each thrust unit within the thrust unit stack 1000 are critical in maximizing the overall thrust production of the stack.

For example, when similarly configured thrust units are stacked along a central axis, wherein the conductive layers of each of the thrust units are parallel to each other, and each of the thrust units are spaced at a distance that is at least greater than the Rindler horizon distance as perceived by the electrons accelerating from the conductive layers of the thrust units within the thrust unit stack 1000, the total amount of thrust produced by the thrust unit stack 1000 is effectively the thrust produced by one of the thrust units multiplied by the number of thrust units in the stack.

By contrast, when the thrust units of the thrust unit stack 1000 are stacked upon each other so that the thrust units are spaced less than the Rindler horizon distance or when the thrust units within the thrust unit stack 1000 are not spaced appropriately, the overall thrust production is reduced due to conflicting thrust vectors that cancel or partially reduce the overall thrust production of the thrust unit stack 1000.

In the disclosed example from FIG. 10, a first thrust unit 1002 and a second thrust unit 1004 may be stacked along a central axis, where the conductive source layer 1006 of the first thrust unit 1002 and the conductive source layer 1008 are parallel to each other. For example, to maximize the overall thrust production of the thrust unit stack 1000, the conductive drain layer 1010 of the first thrust unit 1002 may be spaced at least a predetermined distance 1012 from a conductive cover layer 1014 of the second thrust unit 1004.

For example, in order to maximize the overall thrust production of the thrust unit stack 1000, the predetermined distance 1012 must be at a minimum, greater than the Rindler Horizon perceived by the conductive source layer 1008 of the second thrust unit 1004. By contrast, when the conductive source layer 1008 of the second thrust unit 1004 is less than the predetermined distance 1012 from the conductive drain layer 1010 of the first thrust unit 1002, the close proximity of the first and second thrust units 1002, 1004 can affect the attraction of the charged particles used within the second thrust unit 1004 to the first thrust unit 1002 and reduce the overall amount of thrust produced by the first and second thrust units 1002, 1004. Therefore, first thrust unit 1002 and the second thrust unit 1004 must be positioned at a distance that is at least greater than the predetermined distance 1012 in order to maximize the overall thrust production of the thrust unit stack 1000.

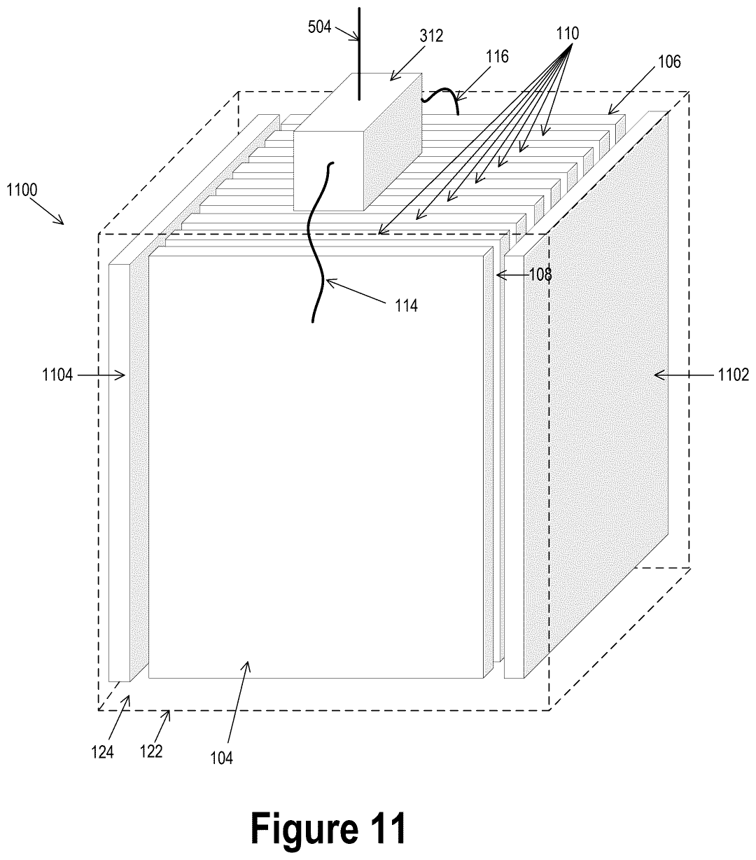

FIG. 11 illustrates an isometric front view of an example configuration of an electro-magnetic thrust unit 1100. For example, the electro-magnetic thrust unit 1100 may use one or more magnetic plates in enhancing the emission of the electrons within the electro-magnetic thrust unit 1100 and thus increase the production of thrust.

In the present example from FIG. 11, the electro-magnetic thrust unit 1100 may be configured to include conductive source layer 104, conductive drain layer 106, conductive middle layers 110, dielectric layers 108, conductive cover layer 122, air-gap 124, controller 312, wires 114 and 116 and thrust bus 504 in a configuration similar to the configuration described in FIG. 1-6.

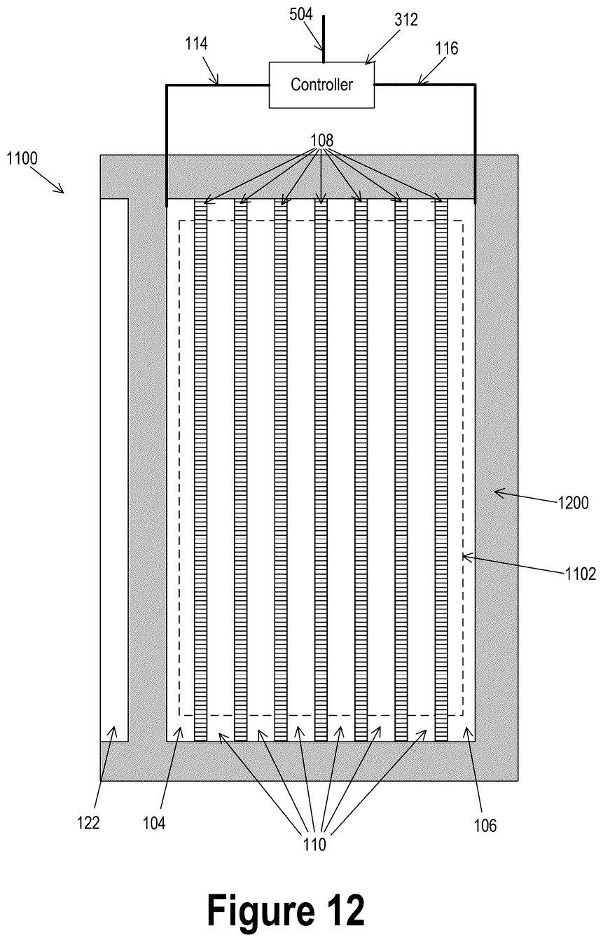

In some examples, although not illustrated in the present example from FIG. 10, the conductive layers 104, 106, 110 and dielectric layers 108 within the electro-magnetic thrust unit 1100 may be arranged along with optional layers such as the optional heating/cooling element 204, 308 and/or optional high-temperature insulative layer 206, 310 in a configuration similar to the thrust unit 102, or electrically reversible thrust unit 302. The composition of the conductive layers 104, 106, 110, 122 and alternate configurations for the dielectric layers 108 and air-gap 124 are described in relation to FIG. 12 below.

In addition to the conductive layers 104, 106, 110, 122 and dielectric layers 108, the electro-magnetic thrust unit 1100 may additionally include one or more magnetic layers to aid in directing the movement and direction of the electrons that are emitted from the conductive layers. The magnetic layers may subject the electrons emitted from the conductive layers 104, 106, 110 to a magnetic field that focuses the electrons and controls the direction of the electrons' movement. Without the magnetic layers, the movement of the electrons emitted from the conductive layers 104, 106, 110 may be random, resulting in inefficiencies in thrust production. Focusing the direction of emitted electrons provides an increase in overall thrust production.

For example, a first magnetic layer 1102 may be positioned adjacent to a first side of the conductive layers 104, 106, 110, and a second magnetic layer 1104 may be positioned adjacent to a second side of the conductive layers 104, 106, 110. Although the example electro-magnetic thrust unit 1100 only includes magnetic layers along two of the sides of the conductive layers 104, 106, 110, magnetic layers may be positioned adjacent along any side of the conductive layers 104, 106, 110, including adjacent to the face of the electro-magnetic thrust unit 1100, such as along a central axis and adjacent to the conductive cover layers 122, 304. For example, the magnetic layer may be stacked adjacent to the conductive cover layer 122, either between the conductive cover layer 122 and the conductive source layer 104 and/or conductive drain layer 106 or on the other side of the conductive cover layer 122 along the central axis.

For example, the magnetic layers, including the first magnetic layer 1102 and second magnetic layer 1104 may be positioned adjacent to any of the sides of the thrust unit 1100 with a layer of non-conductive material disposed between the first magnetic layer 1102 and the second magnetic layer 1104 and the sides of the thrust unit 1100. In some examples, the non-conductive material may include an air-gap 124. Other types of non-conductive materials may also be possible.

In some examples, the first and second magnetic layers 1102, 1104 may be a single magnet that spans the entire length of the side of the conductive layers 104, 106, 110. In other examples, the first and second magnetic layers 1102, 1104 may be composed of a plurality of magnetic strips spanning a portion of the side of the conductive layers 104, 106, 110. For example, the first magnetic layer 1102 and second magnetic layer 1104 may be permanent magnets or electromagnets. The use of electromagnets in the electro-magnetic thrust unit 1100 may facilitate further control over the thrust produced by the electro-magnetic thrust unit 1100. For example, an electromagnet may be turned on or off to increase or decrease the overall thrust production of the electro-magnetic thrust unit 1100. Further, polarity of the magnets may be reversed if necessary.

In some configurations, the first magnetic layer 1102 and the second magnetic layer 1104 may be mounted such that the north pole of the first magnetic layer 1102 and the second magnetic layer 1104 face the first side and second side of the conductive layers 104, 106, 110 respectively. In other examples, the first magnetic layer 1102 and second magnetic layer 1104 may be configured in a different direction.

FIG. 12 illustrates a side view of the example electro-magnetic thrust unit 1100 from FIG. 11. For example, the side view of the example electro-magnetic thrust unit 1100 illustrates the conductive source layer 104, the conductive drain layer 106, the conductive middle layers 110, the conductive cover layer 122, dielectric layers 108, the controller 312, the wires 114, 116 to dispel electrical energy evenly across the conductive source layer 104 and conductive drain layer 106, and a thrust bus 504 to connect the controller 312 to the main electrical power supply and computing system to receive power and data inputs and first magnetic layer 1102 configured to be parallel to the edges of the conductive layers 104, 106, 110.

In some examples, the conductive source layer 104, the conductive drain layer 106 and the conductive middle layers 110 may be composed of anodized aluminum plates that are stacked in a “sandwich” like configuration. The use of anodized aluminum eliminates the need to use dielectric layers 108 between the conductive layers 104, 106, 110. The conductive cover layer 122 may be composed of a conductive material. In some examples, the conductive cover layer 122 may be composed of anodized aluminum. In other examples, the conductive cover layer 122 can be composed of other types of conductive materials as well.

For example, when the conductive layers 104, 106, 110, 122, are composed of anodized aluminum, the need to have a separate dielectric layer 108 and air-gap 124 may be eliminated. Instead, each conductive layer and adjacent dielectric layer, such as the conductive source layer 104 and the adjacent dielectric layer 108 may together be composed of anodized aluminum. Thus the thrust unit 1100 may include layers of anodized aluminum instead of alternating conductive and dielectric layers. In other examples, the conductive layers 104, 106, 110, 122 may be composed of a conductive material such as aluminum and the dielectric layers 108 may be composed of a dielectric medium such as polyamide, aluminum oxide, high-density polyethylene (HDPE) or low-density polyethylene LDPE. Other types of conductive materials and dielectric mediums are also possible.

A non-conductive filler 1200 may be configured to surround the top and bottom edges of the conductive layers 104, 106, 110, 122 to keep the electrostatic stack of anodized aluminum plates used for the conductive layers 104, 106, 110, from interacting with the surroundings. In some examples, the non-conductive filler 1200 may be composed of a non-conductive material such as plastic, ceramic, fibers, multi-layer insulation, or rubber. The non-conductive filler 1200 may be composed of other types of non-conductive materials as well.

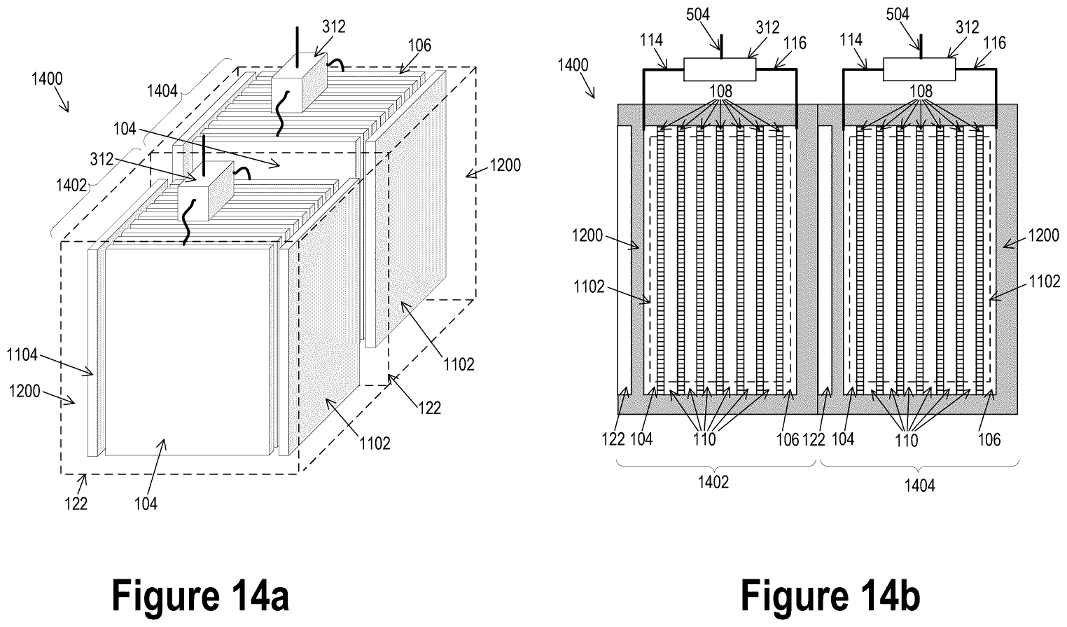

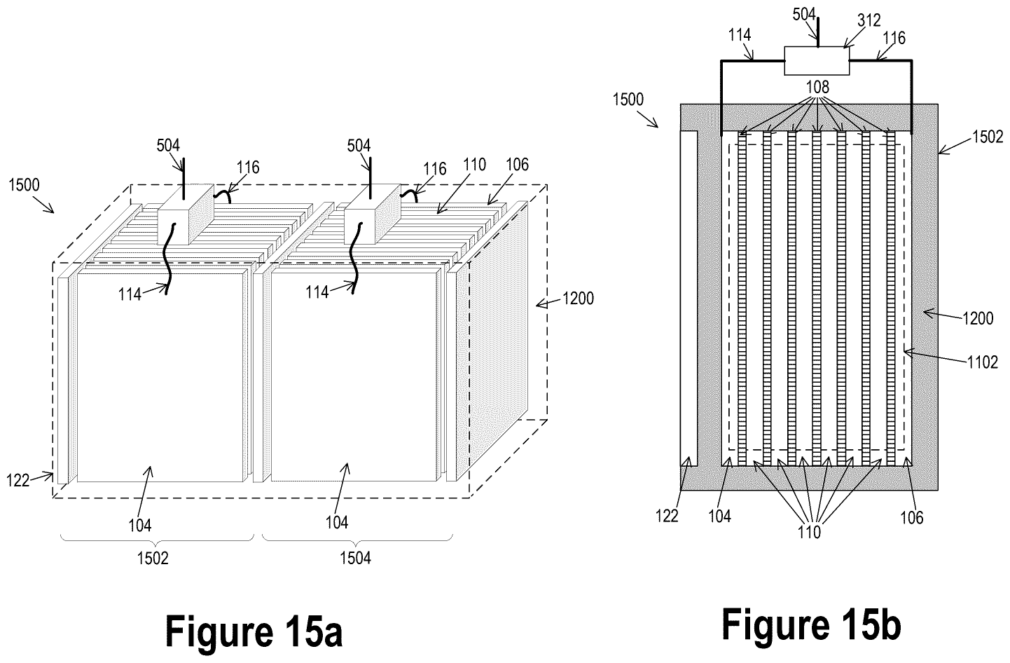

In some examples, the non-conductive filler 1200 may extend past the conductive drain layer 106 for a thickness equal to at least the Rindler Horizon distance such that the electro-magnetic thrust unit 1100 can be stacked adjacent to another electro-magnetic thrust unit 1100 to form a stacked configuration that minimizes interference between each of the electro-magnetic thrust unit 1100 within the stacked configuration. A stacked configuration of electro-magnetic thrust units is further described in relation to FIGS. 14 and 15 below.

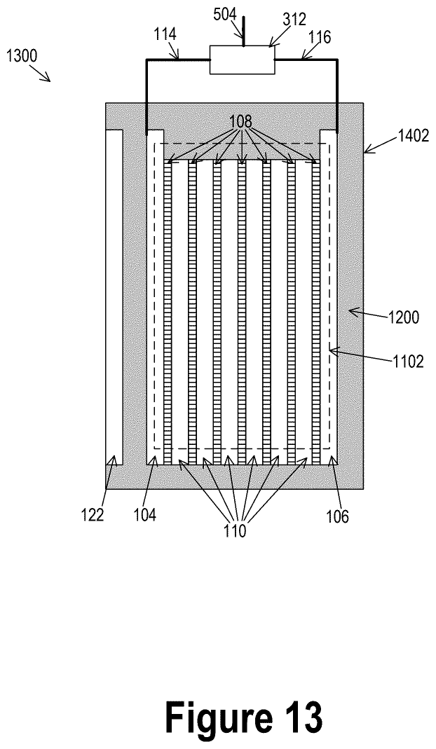

FIG. 13 illustrates an example alternative configuration of the electro-magnetic thrust unit 1300. The electro-magnetic thrust unit 1300 may be configured to include conductive source layer 104, conductive drain layer 106, conductive middle layers 110, conductive cover layer 122, controller 312, wires 114, 116 to dispel electrical energy evenly across the conductive source layer 104 and conductive drain layer 106 and thrust bus 504 to connect the controller 312 to the main electrical power supply and computing system to receive power and data inputs.

For example, the conductive middle layers 110 of the electro-magnetic thrust unit 1300 may be configured to be shorter in length than the conductive source layer 104 and conductive drain layer 106. The shorter length of the conductive middle layers 110 may provide a practical advantage by providing additional space to accommodate wires 114, 116 as the wires are connected between the controller 312 and the conductive source layer 104 and conductive drain layer 106. Other configurations for the conductive layers 104, 106, 110, 122 are also possible.

FIG. 14, which includes FIGS. 14a and 14b, illustrates different views of a stack of electro-magnetic thrust units 1400. FIG. 14a illustrates an example isometric front view of the stack of electro-magnetic thrust units 1400 and FIG. 14b illustrates an example side view of the stack of electro-magnetic thrust units 1400.

The stack of electro-magnetic thrust units 1400 in FIGS. 14a and 14b includes a first electro-magnetic thrust unit 1402 and a second electro-magnetic thrust unit 1404 stacked adjacent to each other along a single axis, such as the z-axis, such that the conductive source layer 104 of the first electro-magnetic thrust unit 1402 is parallel to the conductive source layer 104 of the second electro-magnetic thrust unit 1404.

For example, the first electro-magnetic thrust unit 1402 and the second electro-magnetic thrust unit 1404 each include the conductive source layer 104, the conductive middle layers 110, conductive drain layer 106 and conductive cover layer 122. In some examples, the first electro-magnetic thrust unit 1402 and the second electro-magnetic thrust unit 1404 may each include a controller 312 and wires 114, 116 that are connected to a thrust bus 504. In other examples, a single controller 312 connected to a thrust bus 504 may be used to control the power and data inputs associated with a plurality of thrust units with multiple wires 114, 116. Other configurations for connecting controller 312 to one or more thrust units are also possible.

In some examples, to maximize thrust production, when the first electro-magnetic thrust unit 1402 and the second electro-magnetic thrust unit 1404 are configured to operate as electrically reversible thrust units, similar to the electrically reversible thrust unit 302 from FIG. 3, instead of including conductive cover layers 122 and 304 on the outer ends of the conductive source layer 104 and the conductive drain layer 106, a single conductive cover layer 122 may be included between the conductive drain layer 106 of the first electro-magnetic thrust unit 1402 and the second electro-magnetic thrust unit 1404. As described in relation to FIG. 10, to maximize thrust production of the stack of electro-magnetic thrust units 1400, the first electro-magnetic thrust unit 1402 and the second electro-magnetic thrust unit 1404 may be spaced such that the conductive cover layer 122 of the second electro-magnetic thrust unit 1404 is at least a predetermined distance 1012 from the conductive drain layer 106 of the first electro-magnetic thrust unit 1402. Other configurations for maximizing thrust production are also possible.

In addition, the first electro-magnetic thrust unit 1402 and the second electro-magnetic thrust unit 1404 may each include a first magnetic layer 1102 and second magnetic layer 1104 on two of the sides of the respective conductive layers 104, 106, 110. In the present examples from FIGS. 14a, and 14b, the second magnetic layer 1104 is only visible in the isometric front view of the stack of electro-magnetic thrust units 1400 of FIG. 14a. Although the stack of electro-magnetic thrust units 1400 includes two magnetic layers, more or less number of magnetic layers may be included to the one or more sides of the conductive layers 104, 106, 110.

The first electro-magnetic thrust unit 1402 and the second electro-magnetic thrust unit 1404 may be electrically separated from each other by the non-conductive filler 1200. Electrically isolating the first electro-magnetic thrust unit 1402 and the second electro-magnetic thrust unit 1404 facilitates the emission of electrons by the conductive layers 104, 106, 110 and 122 and results in the efficient production of thrust.

Although only two electro-magnetic thrust units are included within the stack of electro-magnetic thrust units 1400 in FIGS. 14a and 14b, the stack of electro-magnetic thrust units 1400 may include additional electro-magnetic thrust units to increase the overall amount of thrust produced by the stack of electro-magnetic thrust units 1400.

FIG. 15, which includes FIGS. 15a and 15b, illustrates different views of a stack of electro-magnetic thrust units 1500. FIG. 15a illustrates an example isometric front view of the stack of electro-magnetic thrust units 1500 and FIG. 15b illustrates an example side view of the stack of electro-magnetic thrust units 1500.

The stack of electro-magnetic thrust units 1500 in FIGS. 15a and 15b includes a first electro-magnetic thrust unit 1502 and a second electro-magnetic thrust unit 1504 stacked adjacent to each other along a single plane, such that the conductive source layer 104 of the first electro-magnetic thrust unit 1502 is parallel to the conductive source layer 104 of the second electro-magnetic thrust unit 1504. In the present examples from FIGS. 15a, and 15b, the second electro-magnetic thrust unit 1504 is only visible in the isometric front view of the stack of electro-magnetic thrust units 1500 of FIG. 15a.

For example, the first electro-magnetic thrust unit 1502 and the second electro-magnetic thrust unit 1504 each include the conductive source layer 104, the conductive middle layers 110, conductive drain layer 106 and conductive cover layer 122. The first electro-magnetic thrust unit 1502 and the second electro-magnetic 1504 also each include a controller 312, wires 114, 116 and thrust bus 504.

In addition, the first electro-magnetic thrust unit 1502 and the second electro-magnetic thrust unit 1504 may each include a first magnetic layer 1102 and second magnetic layer 1104 on two of the sides of the respective conductive layers 104, 106, 110. In the present examples from FIGS. 15a, and 15b, the second magnetic layer 1104 is only visible in the isometric front view of the stack of electro-magnetic thrust units 1500 of FIG. 15a. Although the stack of electro-magnetic thrust units 1500 includes two magnetic layers, more or less number of magnetic layers may be included to the one or more sides of the conductive layers 104, 106, 110.

The first electro-magnetic thrust unit 1502 and the second electro-magnetic thrust unit 1504 may be electrically separated from each other by the non-conductive filler 1200. Electrically isolating the first electro-magnetic thrust unit 1502 and the second electro-magnetic thrust unit 1504 facilitates the emission of electrons by the conductive layers 104, 106, 110 and 122 and results in the efficient production of thrust.

Although only two electro-magnetic thrust units are included within the stack of electro-magnetic thrust units 1500 in FIGS. 15a and 15b, the stack of electro-magnetic thrust units 1500 may include additional electro-magnetic thrust units to increase the overall amount of thrust produced by the stack of electro-magnetic thrust units 1500.

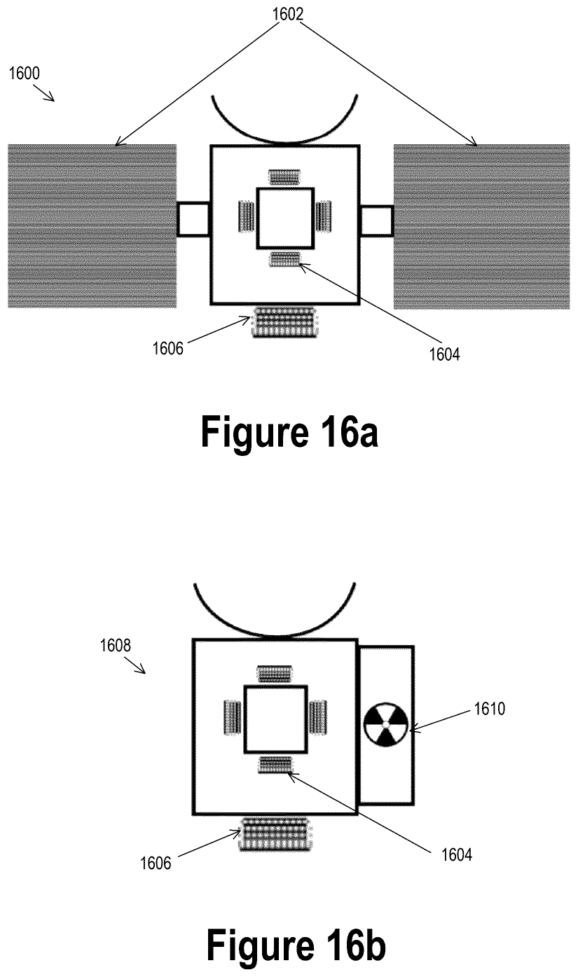

FIG. 16, which includes FIGS. 16a and 16b, illustrates example implementations of thrust units in a satellite.

FIG. 16a illustrates an example configuration of a satellite 1600 that is powered by solar arrays 1602. For example, the satellite 1600 may include one or more station thrust units 1604 and one or more main orbit changing thrust unit 1606. The one or more station thrust units 1604 and one or more main orbit changing thrust unit 1606 each include a stack of thrust units that together produce thrust that can be used to propel the satellite 1600.

For example, the stack of thrust units, as well as each of the thrust units and associated controllers and thrust bus(es) within the stack of thrust units may be implemented using any of the configurations described in FIGS. 1-15. Together the one or more station thrust units 1604 and the one or more main orbit changing thrust unit 1606 may control all one or more aspects of changing the velocity, rotation, and/or orbit of the satellite 1600. The one or more station thrust units 1604 and one or more main orbit changing thrust unit 1606 may be powered by the solar arrays 1602.

FIG. 16b illustrates an example configuration of a satellite 1608 that is powered by nuclear power 1610. For example, the satellite 1608 may include one or more station thrust units 1604 and one or more main orbit changing thrust unit 1606. The one or more station thrust units 1604 and one or more main orbit changing thrust unit 1606 each include a stack of thrust units that together produce thrust that can be used to propel the satellite 1608.

For example, the stack of thrust units, as well as each of the thrust units and associated controllers and thrust bus(es) within the stack of thrust units may be implemented using any of the configurations described in FIGS. 1-15. Together the one or more station thrust units 1604 and the one or more main orbit changing thrust unit 1606 may control all one or more aspects of changing the velocity, rotation, and/or orbit of the satellite 1608. The one or more station thrust units 1604 and one or more main orbit changing thrust unit 1606 may be powered by nuclear power 1610.

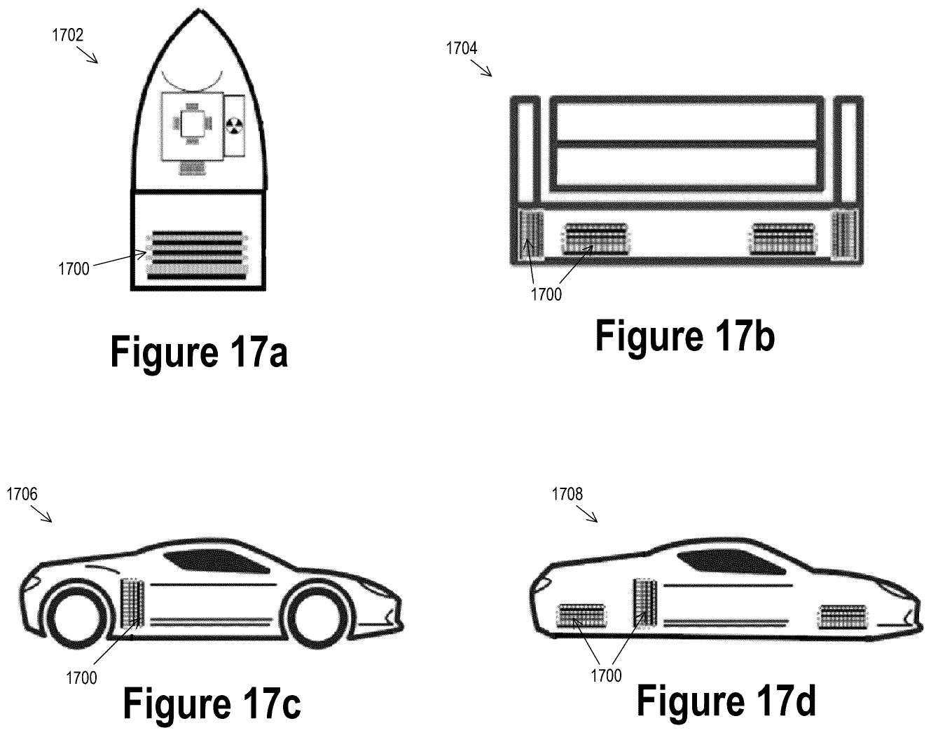

FIG. 17, which includes FIGS. 17a-d, illustrate example implementations of thrust units in different commercial applications.

For example, thrust unit 1700 can be used to produce thrust for different commercial applications. Although thrust unit 1700 is shown as a single thrust unit in FIGS. 17a-d, in reality, thrust unit 1700 may include one or more thrust units or one or more stacks of thrust units may be used to propel different types of vehicles. For example, the stack of thrust units, as well as each of the thrust units and associated controllers and thrust bus(es) within the stack of thrust units represented by thrust unit 1700 in FIGS. 17a-d may be implemented using any of the configurations described in FIGS. 1-15.

FIG. 17a illustrates an example implementation of thrust unit 1700 in a satellite launching device 1702.

FIG. 17b illustrates an example implementation of thrust unit 1700 in a lift device 1704 designed to move humans, animals and/or things. For example, the lift device 1704 may include one or more thrust units 1700 that provide the velocity, orientation and propulsion needed for the operation of the lift device 1704.

FIG. 17c illustrates an example implementation of thrust unit 1700 in a conventional vehicle 1706. For example, a conventional vehicle 1706 may be fitted with one or more thrust units 1700 to propel and/or slow down the conventional vehicle 1706. Using one or more thrust units 1700 in a conventional vehicle 1706 may cause the conventional vehicle to be more energy efficient.

FIG. 17d illustrates an example implementation of thrust unit 1700 in a hovering vehicle 1708. For example, as an alternative to conventional vehicle 1706 that includes wheels, the hovering vehicle 1708 may use one or more thrust units 1700 to hover or elevate the vehicle in addition to propelling and/or slowing down the hovering vehicle 1708. For example, a hovering vehicle could be an alternative to conventional automobiles, buses, trains, airplanes, boats and even drones.

Although not illustrated in FIG. 17, the thrust unit 1700 may be included in other types of practical application that requires any type of propulsion, including: a jetpack to propel humans, a thrust plate used to move heavy or large objects, cranes for lifting objects, hovering stretchers or gurneys, hoverboards, etc.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A thrust device comprising:
a first cover layer including a central axis;
a first conductive layer positioned a first distance from the first cover layer about the central axis, wherein the first conductive layer is connected to a first terminal of a controller;
a second conductive layer positioned a second distance from the first conductive layer about the central axis, wherein the second conductive layer is connected to a second terminal of the controller;
a non-conductive medium positioned between the first cover layer and the first conductive layer; and
at least one dielectric layer positioned between the first conductive layer and the second conductive layer,
wherein, upon a current being applied by the controller between the first conductive layer and the second conductive layer, thrust is produced by the thrust device in a first direction when electrons accelerate in a second direction, wherein the first direction is opposite of the second direction.

2. The thrust device of claim 1, wherein the first distance and the second distance are at least shorter than a Rindler horizon distance, the Rindler horizon distance being based on a path of constant proper acceleration as observed by the electrons accelerating between the first conductive layer and the second conductive layer.

3. The thrust device of claim 1, further comprising:
a second cover layer positioned a third distance from the second conductive layer, wherein the third distance is at least shorter than a Rindler horizon distance observed by the electrons; and
a second non-conductive medium positioned between the second conductive layer and the second cover layer;
wherein the first cover layer is electrically insulated from the first conductive layer and the second cover layer is electrically insulated from the second conductive layer; and
wherein a surface area of the first cover layer is at least the same size as a surface area of the first conductive layer and a surface area of the second cover layer is at least the same size as a surface area of the second conductive layer.

4. The thrust device of claim 1, wherein when a polarity of the current being applied by the controller is reversed, the direction of the thrust produced is also reversed.

5. The thrust device of claim 1, wherein the controller receives power from a power source to supply the current to the first conductive layer and the second conductive layer and wherein the controller receives a data input from a computing device, wherein the data input controls a magnitude and direction of the current supplied to the first conductive layer and the second conductive layer.

6. The thrust device of claim 5, wherein the power source is a renewable power source.

7. The thrust device of claim 1, wherein the first conductive layer comprises a first edge and the second conductive layer comprises a second edge, wherein the first edge and the second edge are positioned along a same plane.

8. The thrust device of claim 7, further comprising one or more magnets extending from the first edge of the first conductive layer to the second edge of the second conductive layer.

9. The thrust device of claim 1, further comprising one or more layers positioned between the first conductive layer and the second conductive layer, wherein each of the one or more layers includes a dielectric layer coupled to a conductive middle layer.

10. The thrust device of claim 1, wherein the first conductive layer and the second conductive layer are composed of aluminum.

11. The thrust device of claim 1, wherein the non-conductive layer is an air-gap and the dielectric layer is composed of a dielectric medium.

12. The thrust device of claim 1, wherein each of the first conductive layer, the second conductive layer, and the first cover layer are positioned parallel to one another.

13. A thrust system comprising:
an object; and
a plurality of thrust devices coupled to the object to propel the object, wherein each of the plurality of thrust devices comprises:
a first cover layer including a central axis;
a first conductive layer positioned a first distance from the first cover layer about the central axis, wherein the first conductive layer is connected to a first terminal of a controller;
a second conductive layer positioned a second distance from the first conductive layer about the central axis, wherein the second conductive layer is connected to a second terminal of the controller;
a non-conductive medium positioned between the first cover layer and the first conductive layer; and
at least one dielectric layer positioned between the first conductive layer and the second conductive layer,
wherein, upon a current being applied by the controller between the first conductive layer and the second conductive layer, thrust is produced by the thrust device in a first direction when electrons accelerate in a second direction, wherein the first direction is opposite of the second direction.

14. The thrust system of claim 13, wherein the object includes one of: a satellite, a satellite launcher, an automobile, and spacecraft.

15. The thrust system of claim 13, wherein each of the thrust devices in the plurality of thrust devices is arranged such that the first conductive layer of each of the thrust devices is along a same plane.

16. The thrust system of claim 13, wherein each of the thrust devices in the plurality of thrust devices is arranged along the central axis with the first conductive layer of each of the thrust devices positioned parallel to each other.

17. The thrust system of claim 13, wherein each of the thrust devices in the plurality of thrust devices is arranged at a distance that is at least greater than a path of constant proper acceleration as observed by electrons accelerating within each of the thrust devices.

18. The thrust system of claim 13, further comprising one or more magnets extending from a first edge of the first conductive layer to a second edge of the second conducting layer of each thrust device, wherein the first edge of the first conductive layer and the second edge of the second conductive layer are along a same plane.

19. A reversible thrust device comprising:
a first cover layer including a central axis;
a first anodized layer positioned a first distance from the first cover layer about the central axis, wherein the first anodized layer is connected to a first terminal of a controller;
a second anodized layer a second distance from the first anodized layer about the central axis, wherein the second anodized layer is connected to a second terminal of the controller;
a second cover layer a third distance from the second anodized layer about the central axis;
a first non-conductive medium positioned between the first cover layer and the first anodized layer; and
a second non-conductive medium positioned between the second anodized layer and the second cover layer,
wherein, upon a current being applied by the controller between the first conductive layer and the second conductive layer, thrust is produced by the thrust device in a first direction when a flow of electrons is in a second direction, wherein the first direction is opposite of the second direction.

20. The reversible thrust device of claim 19, further comprising:
at least one magnet extending from a first edge of the first anodized layer to a second edge of the second anodized layer, wherein the first edge of the first anodized layer and the second edge of the second anodized layer are along a same plane.
